(19) United States
(12) Patent Application Publication
(10) Pub. No.: US 2010/0292395 A1
(43) Pub. Date: Nov. 18, 2010

(54) PROCESS FOR THE MANUFACTURE OF AT LEAST PARTIALLY HYDROLYZED CHLOROSULFONATED POLYOLEFIN ELASTOMERS IN OIL

(75) Inventor: Royce E. Ennis, Silsbee, TX (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(73) Assignee: DuPont Performance Elastomers L.L.C., Wilmington, DE (US)

(21) Appl. No.: 12/465,139

(22) Filed: May 13, 2009

(51) Int. Cl. C08L 9/00; C08L 23/06

(52) U.S. Cl. 524/574; 524/570; 524/585

(57) ABSTRACT

A process for the manufacture of an oil concentrate comprising oil and one or more at least partially hydrolyzed chlorosulfonated polyolefin elastomers containing 0.5-50 weight percent chlorine and 0.25 to 5 weight percent sulfur is disclosed.

### FIELD OF THE INVENTION

This invention relates to preparation of partially hydrolyzed chlorosulfonated polyolefin elastomers in oil wherein said chlorosulfonated polyolefin elastomers have a plurality of pendant —SO₃H groups.

### BACKGROUND OF THE INVENTION

Chlorosulfonated polyethylene elastomers and chlorosulfonated ethylene copolymer elastomers have been found to be excellent elastomeric materials for use in applications such as wire and cable jacketing, molded goods, automotive hose, power transmission belts, roofing membranes and tank liners. These materials are noted for their balance of oil resistance, thermal stability, ozone resistance and chemical resistance.

Historically, a wide variety of polyolefin polymers, including ethylene homopolymers and copolymers, have been utilized as the starting polymers (i.e. “base polymers” or “base resins”) for manufacture of chlorosulfonated products. The majority of base polymers employed in the manufacture of chlorosulfonated elastomers have been polyethylene types, e.g. low density polyethylene (LDPE), linear low density polyethylene (LLDPE) and high density polyethylene (HDPE). Most of the ethylene homopolymers and copolymers employed to make these elastomers are polymerized by a high pressure free radical catalyzed process or by a low pressure process using Ziegler-Natta or Phillips type catalysts.

U.S. Pat. No. 5,668,220 discloses chlorinated and chlorosulfonated elastomers that contain 20-50 weight percent chlorine and 0.8-2.5 weight percent sulfur. These elastomers are made from ethylene/alpha-olefin copolymers that were polymerized in the presence of a single site or metallocene catalyst. Such ethylene copolymers have improved extrusion or flow properties when compared to polymers having the same molecular weight distribution, but produced using a Ziegler-Natta catalyst.

Japanese Kokai Hei 2[1990]-18681 and US 20080249253 A1 disclose polyolefin ionomers containing —SO₃M groups, where M is a univalent cation. The ionomers are made by reacting a portion of the —SO₂Cl groups on a chlorosulfonated polyolefin with base.

Ethylene based elastomers (e.g. EP and EPDM) are utilized as viscosity modifiers for oils in automotive and industrial applications. These polymers are readily soluble and stable in paraffinic and naphthenic oils whereas more polar polymers (e.g. ethylene acrylic or methacrylic copolymers and highly chlorinated ethylene polymers) are not.

Isobutylene based elastomers (e.g. PIB and isobutylene/diene copolymers) have traditionally been used as modifying agents for motor oils and greases to enhance their utility at higher temperatures.

Styrene based elastomers (e.g. SBS and SIS block copolymers and preferably their hydrogenated derivatives) have also shown application as viscosity modifiers in oil formulations and adhesives applications.

Propylene based polymers (e.g. atactic polypropylene and propylene/ethylene copolymers) have been utilized as adhesives and bonding agents as well as viscosity modifiers in industrial applications.

Many of these polymers are functionalized, via grafting techniques, with reactive groups (e.g. maleic anhydride) in order to incorporate stabilizers for oil-based formulations. These modified functionalized polymers enhance oil stability and prevent deposit formation in equipment.

These polymers normally require extended periods of dissolution time when being added to oils due to residual crystallinity that must be overcome and/or the need to breakup the high molecular weight polymer through difficult polymer grinding techniques before addition to the oil.

US 20080249218 A1 discloses the at least partial neutralization of chlorosulfonated polyolefins in oil. However, the resulting polyolefin sulfonates cannot be converted to the acid form suitable for some end uses and concentrates of the polyolefin sulfonates can be difficult to dilute with additional oil.

It would be desirable to have an oil based solution or emulsion concentrate of partially hydrolyzed chlorosulfonated elastomeric polyolefins (i.e. having pendant sulfonic acid groups) having 0.5 to 50 weight percent chlorine and a moderate to low level of residual crystallinity for use in oil based solutions and emulsions. These solutions or emulsions rapidly dissolve or disperse in oils to greatly reduce formulation preparation. In some of these applications where solution viscosity must be balanced with oil solubility, polymer thermal stability and detergency, it would be desirable to employ a mixture of polyolefins.

### SUMMARY OF THE INVENTION

An aspect of the present invention is a process for the manufacture of an oil composition comprising one or more at least partially hydrolyzed chlorosulfonated polyolefin elastomers, said process comprising:

A) providing a pre-mixture comprising at least one chlorosulfonated polyolefin elastomer, oil and up to 30 weight percent water, based on total weight of said pre-mixture; and

B) shearing said pre-mixture at a sufficient shear and for a sufficient time to form a stable dispersion comprising at least one chlorosulfonated polyolefin elastomer having a plurality of —SO₃H groups.

Another aspect of the invention is a stable oil concentrate dispersion comprising:

A) oil; and

B) 5 to 50 weight percent, based on total weight of concentrate, of at least one chlorosulfonated polyolefin elastomer comprising 0.5 to 50 weight percent chlorine, 0.25 to 5 weight percent sulfur and a plurality of —SO₃H groups.

### DETAILED DESCRIPTION OF THE INVENTION

The oil concentrate of this invention, comprising oil and one or more at least partially hydrolyzed chlorosulfonated polyolefin elastomer, is made by hydrolyzing with water a portion of the pendant —SO₂Cl groups on at least one chlorosulfonated polyolefin elastomer. Typically only about 10 to 90% (as evidenced by FTIR measurements) of the —SO₂Cl groups react with water to form a plurality of —SO₃H groups, so that the elastomers are termed “partially hydrolyzed”. However, fully hydrolyzed elastomers are also considered part of the invention.

Oil that may be employed in this invention includes, but is not limited to mineral oil, paraffinic oil, diesel oil and naphthenic oil.

Chlorosulfonated polyolefin elastomers suitable for use in this invention are those made from base resins selected from the group consisting of ethylene homopolymers, copolymers of ethylene and a C₃-C₂₀ alpha olefin, propylene/ethylene copolymers, ethylene/propylene/diene copolymers, isobutylene/diene copolymers, isobutylene homopolymers, hydrogenated styrene/butadiene block copolymers and hydrogenated styrene/isoprene block copolymers. Base resins of high density polyethylene, low density polyethylene, linear low density polyethylene, ethylene/propylene/diene copolymers, and isobutylene/diene copolymers are preferred. Some of these chlorosulfonated polyolefin elastomers are available under the trade name Hypalon® from DuPont Performance Elastomers. Other chlorosulfonated polyolefin elastomers may be made from the above base resins by any of the various chlorosulfonation processes well known in the art. For example, those disclosed in U.S. Pat. Nos. 3,624,054; 5,668,220; 4,560,731 and EP 131948 A1.

These chlorosulfonated polyolefin elastomers may be semi-crystalline or amorphous. They contain between 0.5 and 50 (preferably between 0.75 and 20, most preferably between 1 and 10) weight percent chlorine and between 0.25 and 5 (preferably between 0.35 and 3, most preferably between 0.5 and 2) weight percent sulfur.

In the general hydrolysis process, a chlorosulfonated polyolefin elastomer, oil and up to 30 weight percent water, based on total weight of pre-mixture, are combined in a pre-mixture. Optionally, only enough water is present to hydrolyze the chlorosulfonated elastomer. If excessive water is present, problems with dispersion stability may arise. If not enough water is present to hydrolyze the chlorosulfonated elastomer, incomplete hydrolysis of the —SO₂Cl groups on the polymer may occur.

The pre-mixture is exposed to high shear mixing in order to form a stable dispersion or solution. Examples of high shear mixing devices include Silverson homomixers and other commercial devices designed for intensive mixing of high viscosity materials. Hydrolysis of the chlorosulfonated polyolefin elastomer may begin during formation of the pre-mixture. However, the hydrolysis reaction may continue in the resulting dispersion after mixing is competed.

Preferably during high shear mixing, the crystalline regions in semi-crystalline chlorosulfonated elastomers are melted in order to promote hydrolysis of pendant —SO₂Cl groups present in crystalline regions. Heating the pre-mixture to above the melting point of these crystalline regions may be accomplished by heat generated from mixing (shear heating) or by an external heat source.

Optionally, rather than beginning the neutralization process with a solid chlorosulfonated polyolefin elastomer that must be dissolved in the oil, a “solvent exchange process” may be employed. In this process, a chlorosulfonated polyolefin elastomer that is already dissolved in a solvent (e.g. carbon tetrachloride, ethylene trichloride, xylene, etc.) is added to the oil in order to exchange the solvent with oil.

The amount of water added to the pre-mixture is typically between 5 and 1000 molar equivalents of water per equivalent of —SO₂Cl groups on the copolymer.

Preferably, the pre-mixture also contains a compatibilizer (e.g. a surfactant or transfer agent) that facilitates hydrolysis of the pendant —SO₂Cl groups on the chlorosulfonated polyolefin elastomer. More than one compatibilizer may be employed. Specific examples of suitable compatibilizers include, but are not limited to anionic surfactants (e.g. sodium lauryl sulfate), metal stearates (e.g. potassium stearate), a metal rosin soap, stearic acid, lauryl alcohol, pentaerythritol, a non-ionic surfactant (e.g. Triton® X-100), or a quaternary ammonium salt (e.g. Quartamin® 24P, available from Kao Corporation). The presence of a compatibilizer is especially useful when the water employed in the hydrolysis process is limited.

Some compatibilizers such as metal salts of carboxylic acids, e.g.

Na or K salts of fatty acids, metal salts of tall oil fatty acids and metal rosin soaps, when employed in excess molar amounts, can result in formation of partially neutralized sulfonate groups, rather than the desired hydrolysis of —SO₂Cl groups to sulfonic acid groups. From this perspective, nonionic compatibilizers such as pentaerythritol and ethoxylated/propoxylated alcohol derivatives (e.g. Triton® X-100) are preferred. The latter may be employed in molar excess and still result in formation of sulfonic acid groups, rather than sulfonate salt groups.

Optionally demineralized water and compatibilizer may be admixed to form a solution or emulsion before addition to an oil—chlorosulfonated polyolefin elastomer admixture.

The resulting dispersion is stable, i.e. it does not form separate layers when stored at room temperature for 24 hours.

Preferably, the dispersion is in the form of a concentrate comprising oil and 5 to 50 weight percent of at least partially hydrolyzed chlorosulfonated polyolefin elastomer, based on total weight of the concentrate. When used in oil formulations, the concentrate may be easily introduced to the formulation at the appropriate (usually diluted) level of partially hydrolyzed chlorosulfonated elastomer.

Concentrates may be packaged (e.g. in drums, pails, bulk container, etc.) by a variety of techniques for distribution and sales, or stored in containers for onsite formulation preparation.

The concentrates of this invention have a variety of end uses such as viscosity modifiers and also for use in adhesives, compatibilizers, reactive cure systems, cured and uncured elastomeric systems, impact modifiers and organosol components. Concentrates are especially useful in facilitating the manufacture of oil formulations wherein a solid partially neutralized chlorosulfonated polyolefin elastomer was traditionally used.

Compounds utilizing the concentrates of the invention may be formulated to contain curatives and other additives typically employed in traditional chlorosulfonated polyolefin compounds.

Useful curatives include bismaleimide, peroxides (e.g. Di-Cup®), sulfur donors (e.g. dithiocarbamyl polysulfides) and metal oxides (e.g. MgO).

Examples of additives suitable for use in the compounds include, but are not limited to i) fillers; ii) plasticizers; iii) process aids; iv) acid acceptors; v) antioxidants and vi) antiozonants.

### EXAMPLES

### Test Methods

Weight percent Cl and S incorporated in chlorosulfonated polyolefin elastomers was measured by the Schoniger combustion method (J. C. Torr and G. J. Kallos, American Industrial Association J. July, 419 (1974) and A. M. MacDonald, Analyst, v86, 1018 (1961)).

The percent of —SO₂Cl groups converted to —SO₃H groups was estimated utilizing Infrared Spectroscopy techniques by examination of the absorption regions for the —SO₂Cl and —SO₃H groups.

Unless otherwise noted, all of the polyolefin base resins employed in the examples were chlorosulfonated according to the process disclosed in U.S. application Ser. No. 12/401,844, filed Mar. 11, 2009.

### Example 1

An ethylene/propylene copolymer (Tafmer® P0080K, available from Mitsui Chemicals, Inc., having a melt flow rate @230° C. of 8.1 g/10 minute (min.) and a density of 0.870 g/cubic centimeter (cc)) was chlorosulfonated. The resulting chlorosulfonated polyolefin contained 3.8 wt. % combined chlorine and 1.15 wt % sulfur. This polymerwas employed as the starting material in this example and in Examples 4 and 8.

A partially hydrolyzed chlorosulfonated polyolefin elastomer of the invention was prepared by first adding 1.6 grams of the chlorosulfonated ethylene propylene copolymer to 150 grams of mineral oil (Bio-base 360 available from Shrieve Chemical Co.), resulting in a 1.06 wt. % solution. The viscosity of this solution was determined to be 33 cps @25° C. This solution was transferred to a 200 ml beaker and stirred at high speed (about 3,000 rpm) with a Silverson homomixer for 1 minute before 2.1 grams of a 10 wt. % aqueous solution of a potassium salt of oleic acid (OCD 607 from Mead Westvaco) (1.2 moles potassium salt per mole of polymer sulfur and 182.2 moles water per mole of polymer sulfur). Mixing was continued at this speed for 5 minutes. The resulting solution of at least partially hydrolyzed polyolefin became noticeably more viscous during stirring, but did not become jelly-like after stirring has ceased.

A sample of the at least partially hydrolyzed polyolefin polymer was isolated by precipitation of a portion of the above solution in a methanol acetone mixture, washed with acetone to further remove mineral oil and dried. A thin pressed film of the hydrolyzed chlorosulfonated polyolefin was then analyzed by FTIR. Infrared bands at 1014 cm⁻¹ and 1130 cm⁻¹ and a broad peak at 3300 cm⁻¹ indicated conversion of the sulfonyl chloride groups to sulfonic acid. Absence of a significant peak at 1166 cm⁻¹ indicated that essentially all of the sulfonyl chloride had been hydrolyzed.

### Comparative Example A

A comparative partially neutralized chlorosulfonated polyolefin elastomer was prepared by mixing a portion of the remaining partially hydrolyzed polyolefin solution prepared in Example 1 above on a Silverson homomixer at 3,000 rpm for 4 minutes while adding 0.75 grams of 10 wt. % aqueous KOH (2.3 moles KOH/mole of polymer sulfur and 65.3 moles water/mole of polymer sulfur). The polymer solution became very viscous with a jelly-like structure immediately. A polymer sample was isolated by precipitation in a methanol:acetone mixture, washed, dried, pressed into a film and analyzed by FTIR. Strong FTIR bands at 1180 and 1051 cm⁻¹ and absence of bands at 1014 cm⁻¹ and 1130 cm⁻¹ indicated formation of the sulfonate potassium salt.

### Example 2

An ethylene/octene copolymer (Engage® 8407, available from The Dow Chemical Co., having a melt index of 30 g/10 minutes (min.) and a density of 0.870 g/cm³) was chlorosulfonated. The resulting chlorosulfonated polyolefin contained 1.97 wt. % chlorine and 1.25% sulfur.

A partially hydrolyzed chlorosulfonated polyolefin elastomer of the invention was prepared using essentially the procedure as in Example 1 by first adding 1.6 grams of the chlorosulfonated ethylene/octene polymer to 150 grams of mineral oil (Bio-base 360) and mixing on a shaker for one hour, resulting in a 1.06 wt. % polymer solution in mineral oil. The viscosity of the solution (Sample A) was determined at several conditions as noted in Table I. The solution was transferred to a 200 ml beaker and stirred at 3,000 rpm for 1 minute with a Silverson homogenizer to ensure complete dissolution. One ml of water was added and then 2 grams of a 10 wt. % aqueous solution of a potassium salt of oleic acid (OCD 607 from Mead Westvaco) was added (1 mole potassium salt per mole of polymer sulfur and 249 moles water per mole of polymer sulfur). Mixing was continued at 5,000 rpm for 5 additional minutes to form an at least partially hydrolyzed chlorosulfonated polyolefin (Sample 1). Sample 1 was set aside for future use and viscosity was determined (see Table I).

A 25 gram portion of Sample 1 was micro-precipitated (using the procedure in Comparative Example A) by slowly adding the sample to 500 ml of a 1:1 mixture of acetone and methanol in a Waring blender at high speed. The isolated polymer was washed with acetone to further remove all of the mineral oil and residual potassium oleate, air dried for 2 hours at 100° C. in a vacuum desiccator and then pressed to a thin film. FTIR analysis of the film showed sharp absorption peaks at 1014 cm⁻¹ and 1130 cm⁻¹ and a broad peak at 3300 cm⁻¹, indicating the formation of a polyolefin sulfonic acid.

### Comparative Example B

A comparative partially neutralized chlorosulfonated polyolefin elastomer was prepared using substantially the procedure in Comparative Example A by mixing remaining Sample 1 solution while adding 1.6 grams of a 5 wt. % aqueous potassium hydroxide solution (2.7 moles KOH per mole of polymer sulfur and 161.3 moles water per mole of polymer sulfur). The polymer solution became more viscous after 2 minutes and thickened to a jelly like consistency when agitation was stopped. The “jelly-like” structure became a pourable fluid upon agitation and reformed upon standing, indicating a thixotropic material. The material was set aside for further viscosity studies (Sample B).

A 25 gram portion of the jelly-like Sample B was micro-precipitated (using the procedure as in Comparative Example A) by slowly adding the sample to 500 ml of a 1:1 (vol.) mixture of acetone and methanol in a Waring blender at high speed. The isolated at least partially neutralized polymer was washed with acetone to further remove all of the mineral oil and residual potassium oleate, air dried for 2 hours at 100° C. in a vacuum desiccator and then pressed to a thin film. FTIR spectra showed strong, sharp peaks at 1051 cm⁻¹ and 1180 cm⁻¹, but no absorption at 1014 cm⁻¹, 1130 cm⁻¹ or 3300 cm^{-1.}

### Example 3

Brookfield viscosity was measured, at 25° C., on Samples 1, A and B, using a #3 spindle at different spindle speeds, starting at 0.5 rpm and increasing to 100 rpm.

TABLE I

| | Sample B | Sample 1 | Sample A |
|---|---|---|---|
| Speed, rpm | Viscosity, cps | Viscosity, cps | Viscosity, cps |
| 1 | 8000 | 1920 | 359 |
| 2 | 6100 | 1600 | 393 |
| 5 | 4800 | 1536 | 347 |
| 10 | 2950 | 1499 | 353 |
| 20 | 1500 | 1392 | 355 |
| 50 | 1100 | 1300 | 350 |
| 100 | 800 | NA | NA |

NA means not available

Sample A, the chlorosulfonated polyolefin of Example 2 dissolved in mineral oil, showed no viscosity dependence on spindle speed. Sample 1, the partially hydrolyzed polyolefin of the invention from Example 2, shows some shear thinning but lacks the strong thixotropic behavior shown in Sample B, the partially neutralized comparative polyolefin of Comparative Example B. Further Sample 1 remained soluble in the oil over an extend time and was easily converted to the potassium sulfonate salt (Sample B) formed by neutralization of Sample 1 with potassium hydroxide to give strong thixotropic behavior.

### Example 4

A partially hydrolyzed chlorosulfonated polyolefin elastomer was prepared using substantially the procedure in Example 1, by adding 1.6 grams of the chlorosulfonated ethylene/propylene copolymer prepared in Example 1 to 150 grams of mineral oil (Bio-base 360) resulting in a 1.06 wt. % solution. The solution was transferred to a 200 ml beaker and stirred at 3,000 rpm for 1 minute with a Silverson homogenizer, then 5 grams of a 20 wt. % aqueous solution of a potassium salt of oleic acid (OCD 607 from Mead Westvaco) was added (5.7 moles potassium salt per mole of polymer sulfur and 386.8 moles water per mole of polymer sulfur). Mixing was continued at 5,000 rpm for 5 additional minutes to form a solution of the at least partially hydrolyzed polyolefin.

A 25 gram sample of the solution was micro-precipitated (using the procedure in Comparative Example A) by slowly adding the sample to 500 ml of a 1:1 mixture of acetone and methanol in a Waring blender at high speed. The isolated polymer was washed with acetone and water to further remove all of the mineral oil and residual potassium oleate, and then air dried for 2 hours at 100° C. in a vacuum desiccator. Polymer was then pressed into a thin film. FTIR analysis of the film showed sharp absorption peaks at 1014 cm⁻¹ and 1130 cm⁻¹ and a broad peak at 3300 cm⁻¹, indicating the formation of a polymer sulfonic acid. A weak adsorption at 1051 and 1180 cm⁻¹ indicative of a potassium sulfonate salt was observed. Based upon peak height ratio its content was <5 wt. % of the mixture.

### Example 5

An ethylene/butene copolymer (Engage® 7447, available from The Dow Chemical Co., having a melt index of 5 g/10 minutes (min.) and a density of 0.865 g/cm³) was chlorosulfonated by substantially the same process as that disclosed in WO 2008/123989 except that no pressure was applied to the system and excess gas was liberated during the process. The resulting chlorosulfonated polyolefin contained 8.3 wt. % chlorine and 1.41 wt. % sulfur. This chlorosulfonated polyolefin was also employed as the starting material in Example 7.

A partially hydrolyzed chlorosulfonated polyolefin elastomer of the invention was prepared using substantially the procedure as in Example 1 by adding 3 grams of the chlorosulfonated ethylene/butene polymer to 197 grams of mineral oil (Bio-base 360) and mixed on a shaker for one hour resulting in a 1.5 wt % solution in mineral oil.

The solution was transferred to a 400 ml beaker and stirred at 3,000 rpm for 1 minute with a Silverson homogenizer to ensure complete dissolution. 5 ml of water was added and 20 grams of a 20 wt. % aqueous solution of a potassium salt of oleic acid (OCD 607 from Mead Westvaco) was added (10.7 moles potassium salt per mole of polymer sulfur and 883.7 moles water per mole of polymer sulfur). Mixing was continued at 5,000 rpm for 5 additional minutes and the solution became much more viscous. The solution of hydrolyzed chlorosulfonated polyolefin was set aside for further use.

A 25 gram sample of the solution was micro-precipitated (using substantially the procedure in Comparative Example A) by slowly adding the sample to 500 ml of a 1:1 mixture of acetone and methanol in a Waring blender at high speed. The isolated hydrolyzed chlorosulfonated polyolefin polymer was washed 3 times with 100 ml aliquots of methanol/acetone/water solution to further remove all of the mineral oil and residual potassium oleate, air dried for 2 hours at 120° C. in a vacuum desiccator and then pressed to a thin film. FTIR analysis of the film showed a sharp absorption peak at 1014, a larger peak at 1051 cm⁻¹ and peaks at 1130 and 1180 cm⁻¹ with a broad peak at 3300 cm⁻¹, indicating the formation of a polymer sulfonic acid. The ratio of peak heights at 1051 cm⁻¹ and 1014 cm⁻¹ indicated that about 80% of the sulfonyl chloride groups had been converted to potassium sulfonate salt. The remainder was present as a sulfonic acid.

### Example 6

An ethylene/propylene copolymer (Tafmer® P0080K, available from Mitsui Chemicals, Inc., having a melt flow rate @230° C. of 8.1 g/10 minute (min.) and a density of 0.870 g/cubic centimeter (cc)) was chlorosulfonated. The resulting chlorosulfonated polyolefin contained 2.2 wt. % combined chlorine and 1.2 wt % sulfur.

A partially hydrolyzed chlorosulfonated polyolefin elastomer of the invention was prepared using substantially the same procedure as in Example 1, by first adding 4.7 grams of the chlorosulfonated ethylene/propylene copolymer to 150 grams of mineral oil (Total DF-1, available from Total Fina Great Britain, Ltd.) resulting in a 3 wt. % solution of chlorosulfonated polyolefin. The solution was stirred with a Silverson homo-mixer at 3,000 rpm for 1 minute to ensure complete dissolution. In a separate container, 2 grams of pentaerythritol was dissolved in 5 ml of water. The pentaerythritol solution was added to the polymer solution and the mixture was stirred at 5,000 rpm for 5 minutes (8.4 moles pentaerythritol per mole of polymer sulfur and 126.2 moles water per mole of polymer sulfur). The solution of partially hydrolyzed polyolefin increased in viscosity during stirring, but became more viscous 30 minutes after mixing had been stopped.

25 grams of the solution of at least partially hydrolyzed polyolefin was micro-precipitated (using substantially the same procedure as in Comparative Example A) in 500 ml of methanol/acetone solution and then washed three times with 100 ml aliquots of 1:1:1 methanol:acetone:water to remove excess pentaerythritol and mineral oil, and then air dried for 2 hours at 100° C. in a vacuum desiccator. The resulting white powder was pressed into a film and analyzed by FTIR. Strong absorption peaks at 1014, 1130 cm⁻¹ and a broad peak at 3300 cm⁻¹ indicated presence of a significant amount of polymer sulfonic acid. A very small peak at 1166 cm⁻¹ indicated that most of the sulfonyl chloride had been hydrolyzed. The absence of a peak at 1051 cm⁻¹ indicated the absence of a detectable amount of the sulfonate salt.

### Comparative Example C

A comparative partially neutralized chlorosulfonated polyolefin elastomer was prepared using substantially the procedure as in Comparative Example A by mixing a portion of the solution of partially hydrolyzed polyolefin prepared in Example 6 with a Silverson homomixer at 3,000 rpm for 5 minutes as 1 gram of CaO was added (12.1 moles CaO/mole polymeric sulfur). The solution became very viscous after standing for 30 minutes.

25 grams of the viscous solution was micro-precipitated (using substantially the same procedure as in Comparative Example A) in 500 ml of methanol/acetone solution and washed three times with 100 ml aliquots of 1:1:1 methanol:acetone:water to remove excess pentaerythritol and mineral oil, and then air dried for 2 hours at 100° C. in a vacuum desiccator. The resulting white powder was pressed into a film and analyzed by FTIR. Absorption peaks at 1051 cm⁻¹ and 1180 cm⁻¹ indicated the presence of polymer sulfonic acid calcium salt.

### Example 7

A partially hydrolyzed chlorosulfonated polyolefin elastomer of the invention was prepared using substantially the same procedure as in Example 1 by adding 3 grams of the chlorosulfonated ethylene/butene polymer prepared in Example 5 to 197 grams of mineral oil (Bio-base 360) and mixed on a shaker for one hour, resulting in a 1.5 wt. % solution of chlorosulfonated polymer in mineral oil.

The solution was transferred to a 400 ml beaker and stirred at 3,000 rpm for 1 minute with a Silverson homogenizer to ensure complete dissolution. One ml of water was added and 2 grams of a 20 wt. % aqueous solution of a potassium salt of oleic acid (OCD 607 from Mead Westvaco) (1 mole potassium salt per mole of polymer sulfur and 109 moles water per mole of polymer sulfur) was added. Mixing was continued at 5,000 rpm for 5 additional minutes and the solution of at least partially hydrolyzed chlorosulfonated polyolefin was set aside for further use.

A 25 gram sample of this solution was micro-precipitated (using substantially the procedure as in Comparative Example A) by slowly adding the sample to 500 ml of a 1:1 mixture of acetone and methanol in a Waring blender at high speed. The isolated polymer was washed 3 times with 100 ml aliquots of 1:1:1 methanol:acetone:water solution to further remove all of the mineral oil and residual potassium oleate, and then air dried for 2 hours at 100° C. in a vacuum desiccator. It was then pressed into a thin film. FTIR analysis of the film showed strong absorption peaks at 1014 cm⁻¹ and 1130 cm⁻¹ and a broad peak at 3300 cm⁻¹, indicating the formation of a polymer sulfonic acid.

### Comparative Example D

A comparative partially neutralized chlorosulfonated polyolefin elastomer was prepared using substantially the same procedure as in Comparative Example A by mixing the remaining solution of at least partially hydrolyzed chlorosulfonated polyolefin of Example 7 while adding 1.6 grams of a 10 wt. % aqueous potassium hydroxide solution (2.5 moles KOH per mole of polymer sulfur and 69.2 moles water per mole of polymer sulfur) while mixing with a Silverson homogenizer at 3,000 rpm for 5 minutes. The polymer solution became more viscous immediately and thickened to a jelly-like consistency when agitation was stopped. The jelly-like structure could be broken down by agitation and reformed upon standing.

A 25 gram sample of the very viscous solution was micro-precipitated (using substantially the same procedure as in Comparative Example A) by slowly adding the sample to 500 ml of a 1:1 mixture of acetone and methanol in a Waring blender at high speed. The isolated polymer was washed 3 times with 100 ml aliquots of 1:1:1 methanol:acetone:water solution to further remove all of the mineral oil and residual potassium oleate, and then air dried for 2 hours at 100° C. in a vacuum desiccator. Dried polymer was then pressed into a thin film. Infra-red spectra showed peaks at 1051 cm⁻¹ and 1180 cm⁻¹, but no absorption at 1014 cm⁻¹ and 1130 cm⁻¹ and 3300 cm⁻¹, indicating that the sulfonic acid groups had been converted to the potassium salt.

### Example 8

A partially hydrolyzed chlorosulfonated polyolefin elastomer of the invention was prepared using substantially the same procedure as in Example 1, by adding 50 grams of the chlorosulfonated ethylene propylene copolymer prepared in Example 1 to 450 grams of mineral oil (Biobase 360) and mixed for one hour on a shaker which resulted in a 10 wt. % chlorosulfonated polyolefin polymer solution.

400 grams of this solution was transferred to a 500 ml beaker and stirred at 5,000 rpm, using a Silverson homomixer, for 1 minute to ensure complete dissolution, which was indicated by a clear transparent appearance. At this point a previously prepared solution of pentaerythritol (2.5 grams of pentaerythritol dissolved in 5 ml of water at 50° C.) was added to the solution of chlorosulfonated polyolefin in mineral oil (1.3 moles pentaerythritol per mole of polymer sulfur and 19.3 moles water per mole of polymer sulfur), stirred at 5,000 rpm for 5 additional minutes and then set aside for further use. This solution of at least partially hydrolyzed chlorosulfonated polyolefin increased in viscosity during stirring, but became more viscous 30 minutes after mixing had been stopped.

A 25 gram sample of the solution was micro-precipitated (using substantially the same procedure as in Comparative Example A) by slowly adding the sample to 500 ml of a 1:1 mixture of acetone and methanol in a Waring blender at high speed. The isolated polymer was washed 3 times with 100 ml aliquots of 1:1:1 methanol:acetone:water solution to further remove excess pentaerythritol and mineral oil, and then air dried for 2 hours at 120° C. in a vacuum desiccator. A portion of the dried polymer was then pressed into a thin film and subjected to Infra-red analysis. Absorption peaks at 1014, 1130 and 3300 cm⁻¹ indicated that hydrolysis of the sulfonyl chloride had taken place, resulting in the presence of polymer sulfonic acid. The absence of a peak at 1051 cm⁻¹ indicated the absence of a detectable amount of the sulfonate salt.

### Comparative Example E

A comparative partially neutralized chlorosulfonated polyolefin elastomer was prepared by mixing 200 grams of the remaining partially hydrolyzed chlorosulfonated polyolefin elastomer polymer solution of Example 8 with a Silverson homomixer at 5,000 rpm for 1 minute while adding 2 grams of a 45 wt. % aqueous potassium hydroxide solution (2.3 moles KOH per mole of polymer sulfur and 8.7 moles water per mole of polymer sulfur). The reaction mixture of at least partially neutralized chlorosulfonated polyolefin became very viscous during the mixing step and then was set aside for further use. After standing for 30 minutes, the viscosity increased to give a thick gel mixture that was not pourable.

A 10 gram sample of the jelly-like material was micro-precipitated (using substantially the same procedure as in Comparative Example A) by slowly adding the sample to 500 ml of a 1:1 mixture of acetone and methanol in a Waring blender at high speed. The isolated polymer was washed with acetone to further remove all of the mineral oil, air dried for 2 hours at 100° C. in a vacuum desiccator and then pressed into a thin film. FTIR scans of the film showed peaks at 1051 cm⁻¹ and 1180 cm⁻¹, indicating the formation of a potassium salt of the polymer sulfonic acid.

### Example 9

10 grams of the remaining partially hydrolyzed chlorosulfonated polyolefin elastomer polymer solution of Example 8 was added to 142 grams of mineral oil to provide a 0.7 wt. % solution of the partially hydrolyzed chlorosulfonated polyolefin of the invention in mineral oil. This solution was mixed for 1 minute in a homomixer and divided into 2 equal parts. One part was set aside for further testing (Sample 2). To the other part, was added 1 gram of 10 wt. % aqueous KOH, and mixed for 1 additional minute in a homomixer at 3,000 rpm (10.3 moles KOH per mole of polymer sulfur and 288.8 moles water per mole of polymer sulfur) to form a comparative neutralized polyolefin (Sample C).

The two samples were allowed to cool to 25° C. and Brookfield viscosity was measured using a #3 spindle at speeds ranging from 0.5 to 100 rpm. The data indicate that formation of the potassium salt (Sample C) in this manner creates a fully dispersed mixture with significant thixotropic behavior.

| | | Viscosity, cps @ 25° C. |
|---|---|---|
| | Viscosity, cps @ 25° C. | Sample C: Polymer |
| | Sample 2: Polymer | sulfonic acid - |
| Spindle speed, rpm | sulfonic acid | potassium salt |
| 0.5 | 2380 | 18150 |
| 5.0 | 1650 | 9250 |
| 10 | 1100 | 4100 |
| 20 | 860 | 1800 |
| 50 | 610 | 950 |
| 100 | 480 | 750 |

### Comparative Example F

10 grams of the remaining partially jelly-like neutralized chlorosulfonated polyolefin elastomer polymer sulfonic potassium salt solution from Comparative Example E was added to 142 grams of mineral oil and attempts were made to disperse the viscous gel-like material in the oil medium (Sample F) using a Silverson homomixer at 3000 rpm. However, it was not possible to make a stable dispersion, even with intense mixing.

After standing for 24 hours at 25° C., Samples 2 and C remained as a single phase, while Sample F separated into two distinct phases (oil on top, polymer on bottom).

What is claimed is:

1. A process for the manufacture of an oil composition comprising one or more at least partially hydrolyzed chlorosulfonated polyolefin elastomers, said process comprising:
A) providing a pre-mixture comprising at least one chlorosulfonated polyolefin elastomer, oil and up to 30 weight percent water, based on total weight of said pre-mixture; and
B) shearing said pre-mixture at a sufficient shear and for a sufficient time to form a stable dispersion comprising at least one chlorosulfonated polyolefin elastomer having a plurality of —SO₃H groups.

2. A process of claim 1 wherein said pre-mixture further comprises at least one compatibilizer selected from the group consisting of anionic surfactants, non-ionic surfactants, metal stearates, metal rosin soaps, stearic acid, lauryl alcohol, pentaerythritol and quaternary ammonium salts.

3. A process of claim 2 wherein said pre-mixture is made by a process comprising:
i) combining at least one chlorosulfonated polyolefin elastomer with oil to form a first admixture;
ii) combining water and at least one compatibilizer to form a second admixture; and
iii) combining said first and second admixtures to form said pre-mixture.

4. A process of claim 1 wherein said pre-mixture is made by combining at least one solid chlorosulfonated polyolefin elastomer with oil, compatibilizer and up to 30 weight percent water.

5. A process of claim 1 wherein said oil is selected from the group consisting of mineral oil, paraffinic oil, diesel oil, and naphthenic oil.

6. A process of claim 1 wherein said chlorosulfonated polyolefin is made from a polyolefin selected from the group consisting of ethylene homopolymers, copolymers of ethylene and a C₃-C₂₀ alpha olefin, propylene/ethylene copolymers, ethylene/propylene/diene copolymers, isobutylene/diene copolymers, isobutylene homopolymers, hydrogenated styrene/butadiene block copolymers and hydrogenated styrene/isoprene block copolymers.

7. A process of claim 6 wherein said polyolefin is an ethylene homopolymer.

8. A process of claim 6 wherein said polyolefin is a copolymer of ethylene and a C₃-C₂₀ alpha olefin.

9. A process of claim 6 wherein said polyolefin is an ethylene/propylene/diene copolymer.

10. A process of claim 6 wherein said polyolefin is an isobutylene/diene copolymer.

11. A stable oil concentrate dispersion comprising:
A) oil; and
B) 5 to 50 weight percent, based on total weight of concentrate, of at least one chlorosulfonated polyolefin elastomer comprising 0.5 to 50 weight percent chlorine, 0.25 to 5 weight percent sulfur and a plurality of —SO₃H groups.

12. An oil concentrate of claim 11 wherein said oil is selected from the group consisting of mineral oil, paraffinic oil, diesel oil, and naphthenic oil.

13. An oil concentrate of claim 11 wherein said chlorosulfonated polyolefin elastomer is made from a polyolefin selected from the group consisting of ethylene homopolymers, copolymers of ethylene and a C₃-C₂₀ alpha olefin, propylene/ethylene copolymers, ethylene/propylene/diene copolymers, isobutylene/diene copolymers, isobutylene homopolymers, hydrogenated styrene/butadiene block copolymers and hydrogenated styrene/isoprene block copolymers.

14. An oil concentrate of claim 11 wherein said chlorosulfonated polyolefin elastomer comprises 0.75 to 20 weight percent chlorine, 0.35 to 3 weight percent sulfur and a plurality of —SO₃H groups.

15. An oil concentrate of claim 14 wherein said chlorosulfonated polyolefin elastomer comprises 1 to 10 weight percent chlorine, 0.5 to 2 weight percent sulfur and a plurality of —SO₃H groups.
